(19) United States
(12) Patent Application Publication
(10) Pub. No.: US 2026/0138114 A1
(43) Pub. Date: May 21, 2026

(54) Solar-Thermal Microfluidic Spinning Disc Reactor

(71) Applicant: National Technology & Engineering Solutions of Sandia, LLC, Albuquerque, NM (US)

(72) Inventors: Jeffrey Daniel Engerer, Cedar Crest, NM (US); Stacy Harris, Albuquerque, NM (US); Lindsay Lawless, Lafayette, IN (US)

(21) Appl. No.: 18/953,338

(22) Filed: Nov. 20, 2024

(51) Int. Cl. B01J 19/18; B01J 19/00

(52) U.S. Cl. CPC B01J 19/18; B01J 19/0013; B01J 2219/00144

(57) ABSTRACT

An apparatus and method for enhancing mass-transfer rate of reactive species. The apparatus includes an optically transparent stator, a rotor, a pressurized fluid bearing, and a microfluidic channel. The rotor includes a target. The pressurized fluid bearing acts on the target. The pressurized fluid bearing maintains a height of the microfluidic channel. The microfluidic channel is positioned between the optically transparent stator and a reactive surface of the target.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The present disclosure relates generally to solar-thermal testing and more specifically to enhancing rate of mass diffusion of reactive species.

### 2. Background

Fast reactions between gases and solids are often limited by the rate of mass diffusion from the gas phase to the reactive surface. Methods to enhance mass diffusion are commonly leveraged to increase reaction rates to the kinetic limit for many applications. One example is chemical reactors, where faster reaction rates enhance product throughput and/or some quality metric. An additional example is scientific apparatuses, where reaction kinetics can be measured directly.

Techniques for enhancing mass-transfer rate include microfluidics and spinning disc reactors. Each has benefits and downfalls.

Microfluidic phenomena are leveraged to generate fluid bearings for carrying rotational and directional loads. These fluid bearings generally operate on at least one bar of pressure and result in self-stabilizing microchannel on the order of 1-100 microns in size. Shortfalls or difficulties with the use of microfluidics to enhance mass-transfer rate include the requirement for a dimensionally stable system with tight tolerances to avoid unintentional contact between the wall bounding the microfluidic flow. Microfluidics are also generally temperature limited, using low temperature materials incapable of reactions at extreme temperature much above 1000° C.

Spinning disc reactors are commonly used for chemical processing in a temperature-controlled environment, scientific studies of fluid flow and combustion, and for chemical-vapor deposition. Solar-thermal reactors can reach heat fluxes of 1 MW/m2 and temperatures exceeding 2000° C. that are difficult to obtain by other methods. Shortfalls or difficulties with the use of spinning disc reactors to enhance mass-transfer rate include the design of a high temperature apparatus capable of securing the spinning disc beyond the softening, melting, and failure points of most common materials. Also spinning discs enhance mass transfer rate by spinning at higher rates, but with diminishing returns at high RPM's eventually reaching the mechanical limits of all known refractory materials and of rotational bearing technology.

Therefore, it would be desirable to have a method and apparatus that take into account at least some of the issues discussed above, as well as other possible issues.

### SUMMARY

An illustrative embodiment provides an apparatus for enhancing mass-transfer rate of reactive species. The apparatus includes a stator, a rotor, and a fluid bearing between the stator and the rotor. The fluid bearing forms a microfluidic channel.

Another illustrative embodiment provides an apparatus for enhancing mass-transfer rate of reactive species. The apparatus includes an optically transparent stator, a rotor, a pressurized fluid bearing, and a microfluidic channel. The rotor includes a target. The pressurized fluid bearing acts on the target. The microfluidic channel is positioned between the optically transparent stator and a reactive surface of the target.

Another embodiment provides a method for enhancing mass-transfer rate of reactive species. The method includes spacing a rotating target from an optically transparent stator. A microfluidic channel is maintained between a reactive surface of the rotating target and the stator with a pressurized fluid bearing acting on the rotating target. The rotating target is heated with irradiation through the stator.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a solar-thermal microfluidic spinning disc reactor in accordance with an illustrative embodiment;

FIG. 2 is an illustration of a solar-thermal microfluidic spinning disc reactor in accordance with an illustrative embodiment;

FIG. 3 is an illustration of a solar-thermal microfluidic spinning disc reactor in accordance with an illustrative embodiment;

FIG. 4 is an illustration of a cross-section view of a solar-thermal microfluidic spinning disc reactor in accordance with an illustrative embodiment;

FIG. 5 is an illustration of a solar-thermal microfluidic spinning disc reactor in accordance with an illustrative embodiment;

FIG. 6 is an illustration of rotor of a solar-thermal microfluidic spinning disc reactor in accordance with an illustrative embodiment; and

FIG. 7 is an illustration of a flowchart of a process for enhancing mass-transfer rate of reactive species in accordance with an illustrative embodiment.

### DETAILED DESCRIPTION

The illustrative embodiments recognize and take into account one or more different considerations. The issues recognized by the different illustrative embodiments are described herein.

For example, the illustrative embodiments recognize and take into account that fast reactions between gases and solids are often limited by the rate of mass diffusion from the gas phase to the reactive surface.

The illustrative embodiments recognize and take into account that methods to enhance mass diffusion, for example, chemical reactors and/or scientific apparatus are commonly leveraged to increase reaction rates to the kinetic limit and that techniques for enhancing mass-transfer rate include microfluidics and spinning disc reactors.

The illustrative embodiments recognize and take into account that using microfluidics to enhance mass-transfer rate requires a dimensionally stable system with tight tolerances in order to avoid unintentional contact between the wall bounding the microfluidic flow. The illustrative embodiments also recognize and take into account that microfluidics are generally temperature limited, using low-temperature materials incapable of reactions at extreme temperature much above 1000° C.

The illustrative embodiments recognize and take into account that using spinning disc reactors to enhance mass-transfer rate requires a high-temperature apparatus capable of securing the spinning disc beyond the softening, melting and failure points of most common materials. The illustrative embodiments also recognize and take into account that spinning discs enhance mass-transfer rate by spinning at higher rates, but with diminishing returns at high RPMs, eventually reaching the mechanical limits of all known refractory materials and of rotational bearing technology.

The illustrative embodiments combine the technologies of microfluidics and spinning disc reactors to overcome the issues identified above.

The illustrative embodiments include microfluidic phenomena and spinning disc reactions to enhance mass-transfer rates better than either technology can separately. Solar thermal technology creates a localized heating at the surface of the heterogeneous reaction, enabling higher process efficiency and the use of common, lower temperature materials for the supporting infrastructure (spinning shaft, bearings, etc.). Microfluidics enhance mass transfer to rates inaccessible to traditional solar thermal processes (e.g., pressure chambers, packed bed reactors).

The illustrative embodiments maintain a microfluidic gap amidst surface volatilization with a pressurized fluid bearing and mechanical forces acting on a rotor containing a target having a reactive surface. The illustrative embodiments generate uniform reaction rates across the reactive surface. The illustrative embodiments preheat reactive gases and cool a solar thermal window of stator spaced from the rotor.

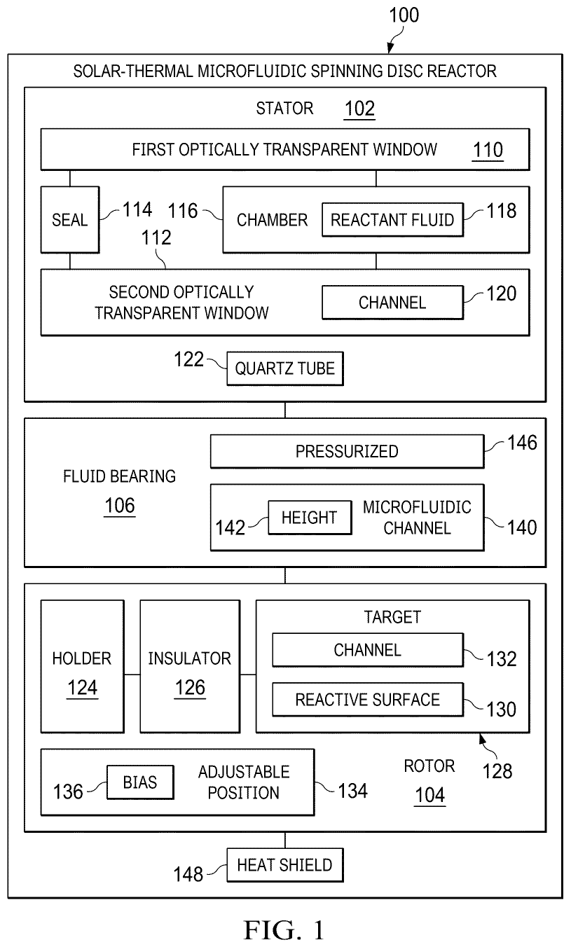

With reference now to the figures and, in particular, with reference to FIG. 1, an illustration of a block diagram of a solar-thermal microfluidic spinning disc reactor is depicted in accordance with an illustrative example. Solar-thermal microfluidic spinning disc reactor 100 includes stator 102, rotor 104, and fluid bearing 106 positioned between stator 102 and rotor 104 in this illustrative example. The illustration of solar-thermal microfluidic spinning disc reactor 100 in FIG. 1 is not meant to imply physical or architectural limitations to the manner in which an illustrative example may be implemented.

In this illustrative example, stator 102 is transparent and includes first optically transparent window 110 spaced from second optically transparent window 112. First optically transparent window 110 is sealed to second optically transparent window 112 with seal 114. First optically transparent window 110 is spaced from second optically transparent window 112 and sealed to form chamber 116. Chamber 116 contains reactant fluid 118. Non-limiting examples of reactant fluid 118 include methane, oxygen, water, carbon dioxide, petroleum products, and natural gas having properties such as chemical reactivity, oxidizing, reducing high thermal conductivity and high diffusivity. Second optically transparent window 112 includes channel 120. Channel 120 provides a conduit for supplying reactant fluid 118 to a reactive surface of a target of rotor 104.

Stator 102 is heated, for example, using irradiation from solar thermal or laser. Stator 102 can be heated to temperatures in the range of 3000 degrees Celsius. It is not necessary to rotate stator 102. The transparency of stator 102 allows reactant fluid 118 contained within chamber 116 to heat up and flow through channel 120 towards rotor 104. First optically transparent window 110 spaced from second optically transparent window 112 may be in the form of quartz tube 122. Quartz tube 122 may include a reactant fluid and a channel for the reactant fluid to flow when heated.

In this illustrative example, rotor 104 is spaced from stator 102 by fluid bearing 106. Rotor 104 includes holder 124. Holder 124 holds insulator 126. Insulator 126 contains target 128. Insulator 126 may include a sleeve to contain target 128. Target 128 is a reactive material. Non-limiting examples of the reactive material of target 128 include metals, refractory alloys, carbon-based materials, catalytic materials, decomposing biofuel feedstock, composites, semiconductors, and porous materials. Target 128 includes reactive surface 130. Reactive surface 130 is the surface of the reactive material of target 128 that faces stator 102. Reactive surface 130 is spaced from stator 102 with fluid bearing 106. Target 128 may include channel 132 for supplying reactant fluid 118 to reactive surface 130. Rotor 104 has an adjustable position 134 relative to stator 102. Adjustable position 134 includes bias 136. Bias 136 urges rotor 104 towards stator 102. Adjustable position 134 allows bias 136 to reposition rotor 104 and thus reactive surface 130 relative to quartz tube 122 or second optically transparent window 112 of stator 102.

Fluid bearing 106 is a fluid flow of reactant fluid 118. Fluid bearing 106 is positioned between stator 102 and rotor 104. Fluid bearing 106 forms microfluidic channel 140. Microfluidic channel 140 has height 142. Non-limiting examples of the composition of fluid bearing 106 may include methane, oxygen, water, carbon dioxide, petroleum products, and natural gas. Height 142 corresponds to the distance between stator 102 and rotor 104. Fluid bearing 106 is pressurized 146 in order to maintain height 142 of microfluidic channel 140. The pressure of fluid bearing 106 urges rotor 104 away from stator 102 in opposition to bias 136 to maintain height 142 of microfluidic channel 140.

Heat shield 148 surrounds rotor 104. Heat shield 148 provides protection from the heat irradiation applied to stator 102.

In use, rotor 104 is rotated with respect to stator 102. Bias 136 urges rotor and thus reactive surface 130 towards stator 102. Fluid bearing 106 is pressurized 146 and opposes bias 136. In other words, fluid bearing 106 is pressurized in order to maintain height 142 of microfluidic channel 140. Reactant fluid 118 flows through channel 120 or channel 132 or both to microfluidic channel 140 in order to react with reactive surface 130.

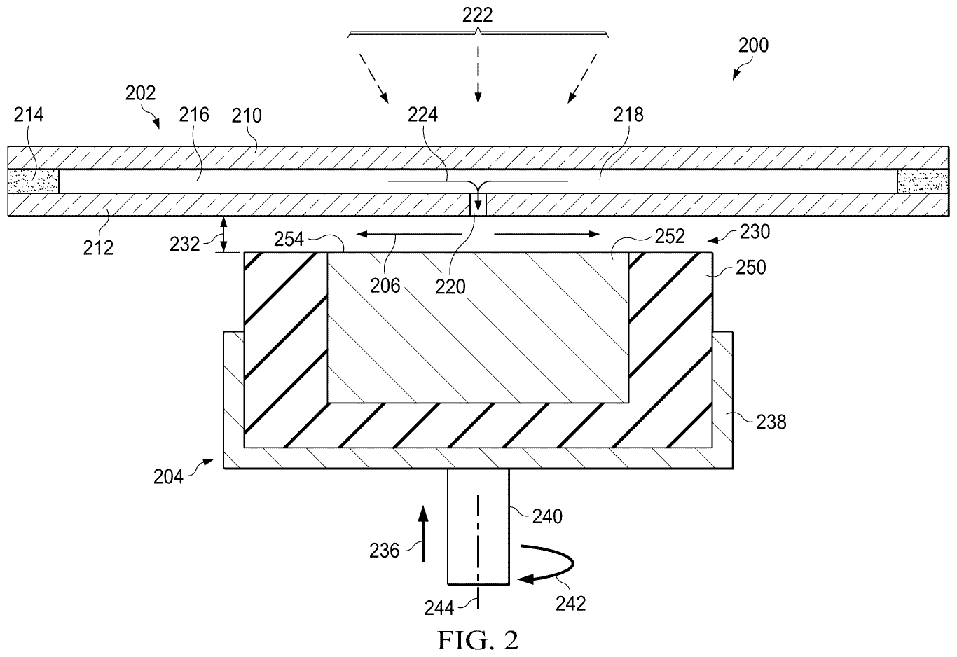

With reference next to FIG. 2, an illustration of a solar-thermal microfluidic spinning disc reactor is depicted in accordance with an illustrative embodiment. In this illustrative example and the illustrative examples that follow, the same reference numeral may be used in more than one figure. This reuse of a reference numeral in different figures represents the same element in the different figures. The components illustrated in FIG. 2 are examples of physical implementations of a solar-thermal microfluidic spinning disc reactor 100, stator 102, fluid bearing 106, and rotor 104 shown in block form in FIG. 1.

As illustrated, solar-thermal microfluidic spinning disc reactor 200 includes stator 202, rotor 204, and fluid bearing 206.

Stator 202 includes first optically transparent window 210 spaced from second optically transparent window 212. First optically transparent window 210 is sealed to second optically transparent window 212 with seal 214. First optically transparent window 210 spaced from and sealed to second optically transparent window 212 forms chamber 216. Reactant fluid 218 is contained within chamber 216. Second optically transparent window 212 includes channel 220. Irradiation 222 in the form of, for example, solar thermal or laser, applied to stator 202 creates reactive flow 224 from chamber 216, through channel 220, toward rotor 204 to create fluid bearing 206. Fluid bearing 206 forms microfluidic channel 230. Microfluidic channel 230 has height 232. Height 232 corresponds to the distance between stator 202 and rotor 204. Fluid bearing 206 is pressurized in order to maintain height 232 of microfluidic channel 230. The pressure of fluid bearing 206 urges rotor 204 away from stator 202 in opposition to bias 236 applied to rotor 204 to maintain height 232 of microfluidic channel 230. Bias 236 is applied to rotor 204 with, for example, springs or a stepper motor.

Rotor 204 includes holder 238. Holder 238 has rotating shaft 240. Rotation 242 of rotating shaft 240 and thus rotor 204 about axis 244 can be accomplished by, for example, a motor. Holder 238 holds insulator 250. Insulator 250 contains target 252. Insulator 250 may also include a sleeve to contain target 252. Target 252 is a reactive material. Target 252 includes reactive surface 254. Reactive surface 254 is the surface of the reactive material of target 252 that faces stator 202. Reactive surface 254 is spaced from stator 202 by fluid bearing 206 forming microfluidic channel 230. Reactant fluid 218 heated within chamber 216 creates reactive flow 224 which flows through microfluidic channel 230 as fluid bearing 206 to react with reactive surface 254. Rotor 204 has an adjustable position relative to stator 202 along axis 244. Bias 236 urges rotor 204 towards stator 202. Fluid bearing 206 urges rotor 204 away from stator 202 in opposition to bias 236 to maintain height 232 of microfluidic channel 230.

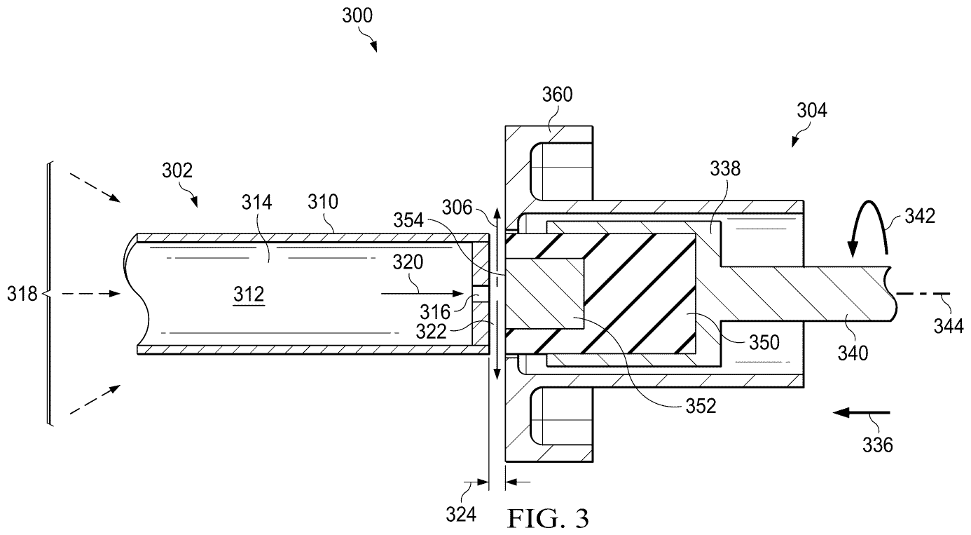

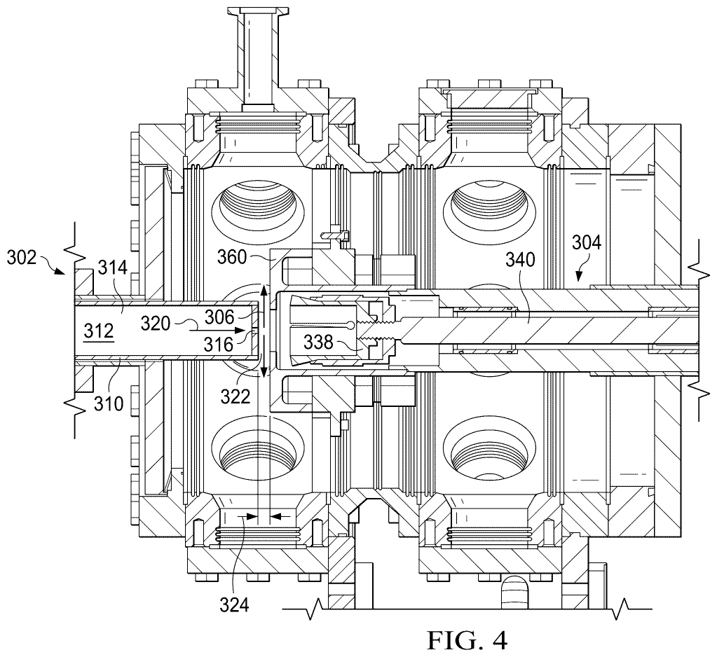

With reference next to FIGS. 3-4, illustrations of a solar-thermal microfluidic spinning disc reactor are depicted in accordance with an illustrative embodiment. The components illustrated in FIGS. 3-4 are examples of physical implementations of a solar-thermal microfluidic spinning disc reactor 100, stator 102, fluid bearing 106, and rotor 104 shown in block form in FIG. 1. FIG. 4 illustrates a solar-thermal microfluidic spinning disc reactor contained within a housing in a cross-section view.

As illustrated, solar-thermal microfluidic spinning disc reactor 300 includes stator 302, rotor 304, and fluid bearing 306.

Stator 302 includes quartz tube 310. Quartz tube 310 forms chamber 312. Reactant fluid 314 is contained within chamber 312. Quartz tube 310 includes channel 316. Irradiation 318 applied to quartz tube 310 creates reactive flow 320 from chamber 312, through channel 316, toward rotor 304 to create fluid bearing 306. Fluid bearing 306 forms microfluidic channel 322. Microfluidic channel 322 has height 324. Height 324 corresponds to the distance between stator 302 and rotor 304. Fluid bearing 306 is pressurized in order to maintain height 324 of microfluidic channel 322.

Rotor 304 includes holder 338. Holder 338 has rotating shaft 340. Rotation 342 of rotating shaft 340 and thus rotor 304 about axis 344 can be accomplished by a motor. Holder 338 holds insulator 350. Insulator 350 contains target 352 (target 352 not shown in FIG. 4). Target 352 is a reactive material. Target 352 includes reactive surface 354. Reactive surface 354 is the surface of the reactive material of target 352 that faces stator 302. Reactive surface 354 is spaced from stator 302 by fluid bearing 306. Reactant fluid 314 heated within chamber 312 creates reactive flow 320 which flows through microfluidic channel 322 as fluid bearing 306 to react with reactive surface 354. Rotor 304 has an adjustable position relative to stator 302 along axis 344. Bias 336 on rotor 304 urges rotor 304 towards stator 302. Fluid bearing 306 urges rotor 304 away from stator 302 in opposition to bias 336 to maintain height 324 of microfluidic channel 322. Heat shield 360 surrounds rotor 304. Heat shield 360 provides protection from heat irradiation 318 applied to stator 302. Heat shield 360, for example, may be water cooled copper or other means known to those skilled in the art.

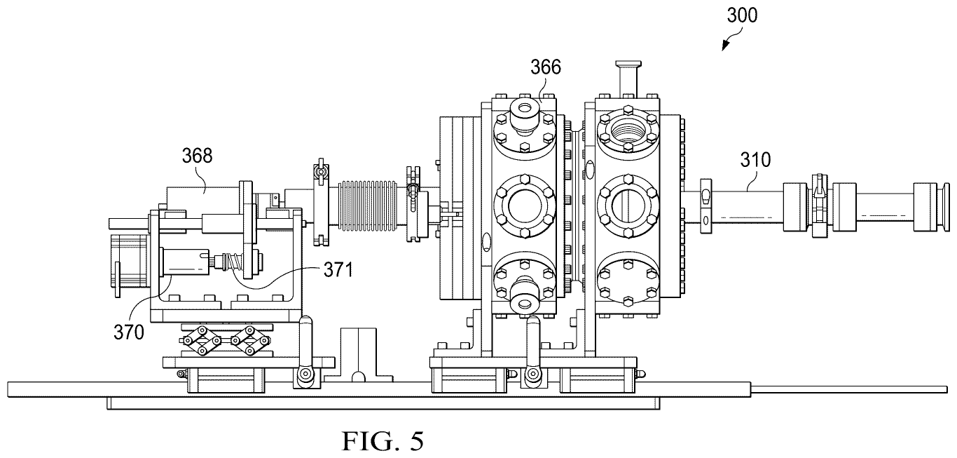

With reference next to FIG. 5, and as shown in FIG. 4, solar-thermal microfluidic spinning disc reactor 300 may be contained within housing 362. Quartz tube 310 extends from housing 366 to be exposed to irradiation. Motor 368 applies rotation to rotating shaft 340 of rotor 304. Stepper motor 370 and spring 371 apply bias 336 to rotor 304.

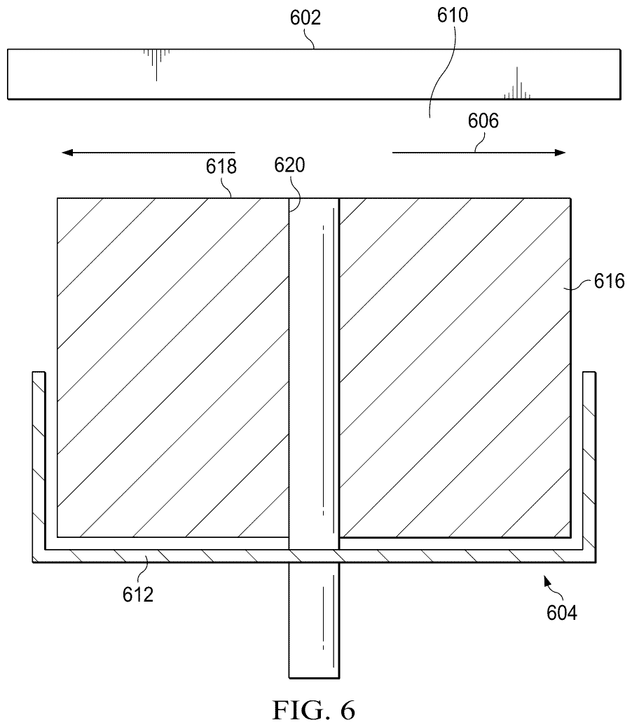

With reference next to FIG. 6, an illustration of a rotor of a solar-thermal microfluidic spinning disc reactor is depicted in accordance with an illustrative embodiment. The components illustrated in FIG. 6 are examples of physical implementations of a rotor 104 shown in block form in FIG. 1.

In this illustrative example, rotor 604 is spaced from stator 602 by fluid bearing 606 forming microfluidic channel 610. Rotor 604 includes holder 612. Holder 612 holds target 616. Target 616 is a reactive material. Target 616 includes reactive surface 618. Reactive surface 618 is the surface of the reactive material of target 616 that faces stator 602. Reactive surface 618 is spaced from stator 602 with fluid bearing 606. Target 616 includes channel 620 for supplying a reactant fluid to reactive surface 618. Heated reactant fluid creates a reactive flow which flows through microfluidic channel 610 as fluid bearing 606 to react with reactive surface 618.

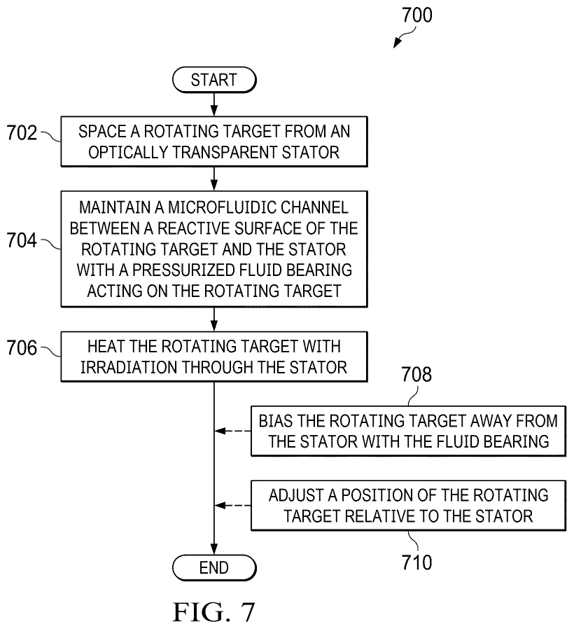

With reference next to FIG. 7, an illustration of a flowchart of a process 700 for enhancing mass-transfer rate of reactive species is depicted in accordance with an illustrative embodiment. The method depicted in FIG. 7 may be used in conjunction with the solar-thermal microfluidic spinning disc reactor depicted in FIGS. 1-6.

The process begins by spacing a rotating target from an optically transparent stator (operation 702). The target is held in a rotor that is biased towards the stator. The process continues by maintaining a microfluidic channel between a reactive surface of the rotating target and the stator (operation 704). The microfluidic channel is maintained with a pressurized fluid bearing acting on the rotating target against the bias acting on the rotor. At operation 706, the process heats the rotating target with irradiation through the stator. At operation 708, the rotating target is biassed away from the stator with the fluid bearing to maintain a height of the microfluidic channel. At operation 710, a position of the rotating target relative to the stator is adjusted toward the stator to affect the height of the microfluidic channel.

In some alternative implementations of an illustrative example, the function or functions noted in the blocks may not be necessary or may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus for enhancing mass-transfer rate of reactive species, the apparatus comprising:
a stator;
a rotor; and
a fluid bearing between the stator and the rotor forming a microfluidic channel.

2. The apparatus of claim 1, wherein the stator comprises an optically transparent window.

3. The apparatus of claim 1, wherein the rotor comprises a target inside an insulator and the target comprises a reactive material or catalyst.

4. The apparatus of claim 3, wherein a holder contains the insulator and the target.

5. The apparatus of claim 1, wherein the rotor comprises a target and the microfluidic channel has a height bounded by a reactive surface of the target and the stator.

6. The apparatus of claim 1, wherein the stator comprises a quartz tube.

7. The apparatus of claim 1, wherein the stator comprises a channel for flowing reactant fluid to the microfluidic channel.

8. The apparatus of claim 1, wherein the stator comprises a first optically transparent window spaced from a second optically transparent window, wherein the second optically transparent window includes a channel in fluid communication with the microfluid channel.

9. The apparatus of claim 1, wherein the rotor is surrounded by a heat shield.

10. The apparatus of claim 1, wherein the fluid bearing is pressurized to maintain a height of the microfluidic channel in a range of 1-100 microns.

11. The apparatus of claim 1, wherein a position of the rotor relative to the stator is adjustable to maintain a height of the microfluidic channel.

12. The apparatus of claim 1, wherein the rotor is biased towards the stator and the fluid bearing is pressurized against the bias to maintain a height of the microfluidic channel.

13. The apparatus of claim 1, wherein the rotor comprises a target and the target comprises a channel in fluid communication with the microfluidic channel.

14. An apparatus for enhancing mass-transfer rate of reactive species, the apparatus comprising:
an optically transparent stator;
a rotor comprising a target;
a pressurized fluid bearing acting on the target; and
a microfluidic channel between the optically transparent stator and a reactive surface of the target.

15. The apparatus of claim 14, wherein the fluid bearing is positioned between the optically transparent stator and the reactive surface of the target to maintain a height of the microfluidic channel.

16. The apparatus of claim 14, wherein the rotor is mechanically biased towards the stator and the fluid bearing is pressurized against the bias to maintain a height of the microfluidic channel.

17. The apparatus of claim 14, wherein the optically transparent stator comprises a channel for flowing reactant fluid to the reactive surface of the target.

18. A method for enhancing mass-transfer rate of reactive species, the method comprising:
spacing a rotating target from an optically transparent stator;
maintaining a microfluidic channel between a reactive surface of the rotating target and the stator with a pressurized fluid bearing acting on the rotating target; and
heating the rotating target with irradiation through the stator.

19. The method of claim 18, further comprising biasing the rotating target away from the stator with the fluid bearing to maintain a height of the microfluidic channel.

20. The method of claim 18, further comprising adjusting a position of the rotating target relative to the stator toward the stator to maintain a height of the microfluidic channel.
